(19) United States
(12) Patent Application Publication
(10) Pub. No.: US 2005/0170170 A1
(43) Pub. Date: Aug. 4, 2005

(54) Transparent plastic label, suitable as cut and stack label for application on normal wet glue labelling equipment, method for producing such labels and labelling technique using such labels

(75) Inventor: Daniel Defrenne, Rebecq (BE)

Correspondence Address: LADAS & PARRY, 26 WEST 61ST STREET, NEW YORK, NY, 10023, US

(73) Assignee: ILLOCHROMA

(21) Appl. No.: 11/029,899

(22) Filed: Jan. 5, 2005

(30) Foreign Application Priority Data
Jan. 15, 2004 (EP) 04447009.4

(51) Int. Cl. B32B 27/08; B32B 27/36; B32B 27/30; B32B 27/32; B32B 27/20; B32B 27/34; B32B 27/42; B32B 27/40

(52) U.S. Cl. 428/323; 156/278; 156/277; 428/423.1; 428/474.4; 428/522; 428/532; 428/524; 428/480; 428/523; 428/335

(57) ABSTRACT

The invention relates to plastic label technology, suitable for cut and stack labels for application on normal wet glue labelling equipment, comprising a label base of plastic sheet material provided with a polymeric base coating having micro-absorption properties for water. Therefor the polymeric base coating preferably comprises a nitro-cellulose base coating material whereas the coating contains a particulate filler material having a particle size ranging from 5 to 50 μ, and the average thickness of the polymeric coating ranges from 10 to 75 % of the average particle size of the particulate filler material. The invention relates to the plastic labels themselves, to the method for producing the labels, and to the use of the labels on glass beverage containers applying normal wet glue labelling technology.

The invention relates to a process for the production of so called cut-and-stack labels for containers, in particular for glass beverage containers in general. The invention more particularly relates to the production of such labels, printed on transparent or translucent plastic sheet material and suitable for application on normal wet glue labelling equipment.

According to the current state of the art drinks- and beverage bottlers have a number of possibilities for labelling their containers: Traditionally bottles have been labelled with paper labels using wet glue; This is done on high speed lines, and requires the label to be absorbent to allow the glue to set. This technique is widespread and common among breweries and other bottlers. The main advantage is that, once the initial investment is made, labelling is both quick and cheap. Alternatively a number of bottlers have switched to pressure-sensitive adhesive (PSA) labels (i.e. self-adhesive labels), allowing the use of plastic as base material for labels. This makes it possible to achieve a see-through look where a transparent plastic is used. However, self-adhesive labelling is much slower and expensive than wet-glue. Furthermore it requires additional investment, as the wet-glue labelling equipment can not be used.

For years bottlers have been searching for a method of applying plastic labels using the wet glue technique. This has been hindered by the fact that the plastic base material absorbs neither air nor water, resulting in bubbles forming under the label.

A number of halfway solutions are already on the market (such as special UV curing glues etc. . . . ). These have known only very limited success due to additional costs or difficulties in applying the labels.

A very thorough review of the state of the art relating to labelling of bottles and containers, and the various developments referred to here above, is reported in U.S. Pat. No. 6,517,664, the content of which is hereby incorporated by reference in the present disclosure.

More recently attempt have been made to develop plastic labels for labelling applications using conventional wet applied water based labelling equipment.

A typical example of such attempt is claimed in U.S. Pat. No. 6,517,664, where plastic labels are proposed using special (“cavitated”) low density polymeric material (i.e. having a density well below 0,9) with a hydrophilic polyacrylate coating, to allow migration of water into the labels.

It is the object of the present invention to provide a further improved plastic label technology suitable for cut and stack labels for application on normal wet glue labelling equipment, which do not require such special low density polymeric material and which can be applied for transparent or translucent plastic labels.

The invention therefor provides transparent or translucent plastic labels, comprising a label base of plastic sheet material provided with a polymeric base coating, optionally comprising mineral pigments and/or antistatic agent(s), wherein the coating involves “micro-absorption properties for water”.

The expression “micro-absorption properties for water”, as used in the present text, refers to a new concept for the surface properties of plastic labels; whereas previous attempts to make plastic labels compatible with wet glue labelling techniques involved the chemical or physico-chemical nature of the label surface, by increasing its hydrophilic character and/or adsorption properties, the concept of absorption or micro-absorption rather involves a purely physical phenomenon, whereby water is retained “imprisoned” on the label surface.

In accordance with the invention the label surface is thus provided with a rugosity or roughness that can retain water by adsorption forces (physical absorption on the surface of the rugosity cavities).

According to a preferred embodiment of the invention these “micro-absorption properties” of the label surface can be achieved by using a polymeric coating which comprises a nitro-cellulose base coating material, whereas the coating contains a particulate filler material having a particle size ranging from 5 to 50 μ, and the average thickness of the polymeric coating ranges from 10 to 75% of the average particle size of the particulate filler material.

The expression “particle size” as used in the present context refers the size most relevant to the surface cavity nature of the coated label, i.e. in essence the “smallest” size of the particles “coated” on the label surface, being in principle the size perpendicular to the label surface.

Whereas the actual size of the particles themselves is not absolutely critical as long as absorbant surface cavities of appropriate size are generated on the coated surface, it is clear that what matters is the proper ratio between the thickness of the base coating layer and the particle size perpendicular to the coated surface.

It is thus, in particular, essential that the thickness of the base coating layer is less than the (relevant) size of the filler particles.

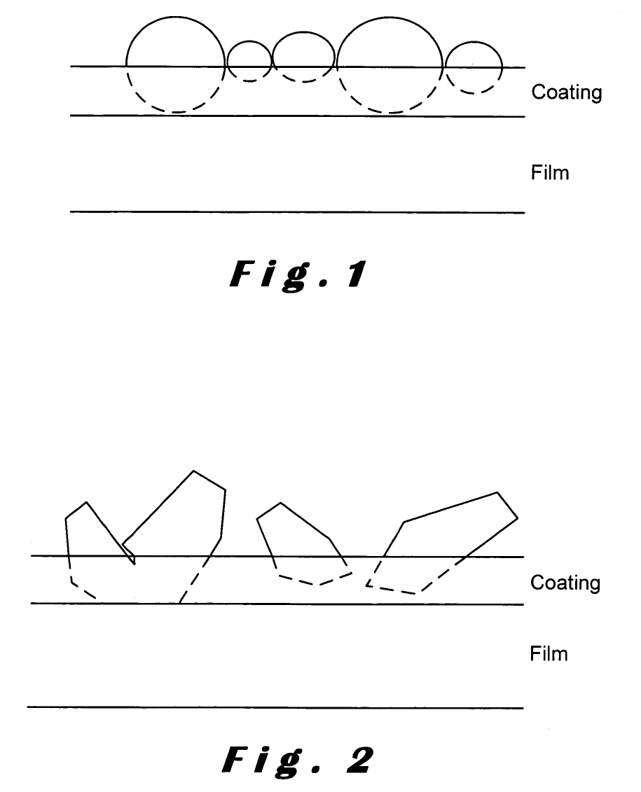

The essential principle of the invention, based on the absorbant surface cavities and surface rugosity or roughness referred to here above is illustrated in the accompanying FIGS. 1 and 2.

A suitable coating thickness is for instance approximately 3 μ for particles having an average size of approximately 12 μ perpendicular to the label surface.

According to the invention the coating of the label sheet material preferably shows

a surface tension of at least 38 dynes/cm,

a dynamic friction coefficient in the range between 0.18 and 0.40, preferably between 0.18 and 0.25, and

a micro-absorption performance involving fast surface absorption, which most preferably stops upon penetration.

Preferred base coating materials for the plastic label according to the invention comprise at least 50% of nitro-cellulose base coatings, polyurethane base coating, polyamide base coating, acrylate base coating, polyvinyl butyral base coating, polyvinyl base coating and/or cellulose acetate base coating (in particular cellulose acetate proprionate base coating); most preferred base coatings are selected from nitro-cellulose base coatings, acrylate base coatings and polyurethane base coatings material (in particular nitro-cellulose acrylate (nitrocellulose-acrylic) and/or nitro-cellulose polyurethane base coatings).

The chemical nature of the filler material is not critical, unlike for wet glue labelling techniques which would rely on the hydrophilic nature of the fillers.

Suitable fillers in accordance with the invention may thus comprise mineral filler materials, polymeric filler powders, microsphere glass fillers, microwax dispersions, etc., such as in particular magnesium silicate, mineral pigments, polyethylene microwaxes and micropowders, glass microbeads, etc.

According to a further preferred feature of the invention, the plastic sheet material of the label base may be selected from “normal” density polymer sheet materials (as opposed to low density polymer sheet materials sometimes referred to as “cavitated”, “micro voided” or foamed polymer material).

The preferred plastic label base for the transparent or translucent labels according to the invention comprises plastic sheet materials selected from polyolefin, polyester or cellulose.

Preferred label base materials comprise plastic sheet materials selected from oriented or bis-oriented polypropylene, having a density equal to or above 0,9 g/cc.

The invention also relates to a method for producing transparent or translucent plastic labels, suitable as cut and stack labels for application on normal wet glue labelling equipment, by providing a transparent or translucent plastic sheet material with a polymeric base coating, optionally comprising mineral pigments and/or antistatic agent(s), wherein a polymeric base coating comprising a nitro-cellulose base coating material and containing a particulate filler material having a particle size ranging from 5 to 50 μ is applied to a plastic sheet material, as a dispersion of the particulate filler in a solution of the base coating material in a volatile solvent, so that the average thickness of the polymeric coating, after evaporation of the solvent, ranges from 10 to 75% of the average particle size of the particulate filler material.

In the method according to the invention, the polymeric base coating comprising nitro-cellulose base coating material and containing particulate filler material is applied to a plastic sheet material, before, during, or after the printing stage, preferably as a dispersion of the particulate filler in a solution of the base coating material in a volatile solvent, so that the average thickness of the polymeric coating, after evaporation of the solvent, ranges from 10 to 75% of the average particle size of the particulate filler material.

According to preferred embodiments of the method according to the invention

the base coating material may comprise at least 50% of a nitro-cellulose acrylate and/or nitro-cellulose polyurethane base coating material;

the particulate filler material may be chosen from mineral filler materials, polymeric filler powders, microsphere glass fillers and microwax dispersions;

the label base may comprise a plastic sheet material selected from polyolefin, polyester or cellulose; and/or

the label base comprises a plastic sheet material selected from oriented or bis-oriented polypropylene, having a density equal to or above 0,9 g/cc.

The invention also relates to the use of a label a set forth hereabove, on glass containers, in particular beverage containers, applying normal wet glue labelling technology.

The new label technology according to the invention is perfectly suitable for application on standard wet labelling equipment, as it is well know to those skilled in the art. A summary review of such equipment is provided in the “Krones Manual of Labeling Technology” by Hermann Kronseder (dec. 1978) the content of which is hereby incorporated by reference in the present disclosure.

The coating according to the invention may suitably involve (an) antistatic agent(s) such as a quaternary ammonium salt(s).

The label sheet material may most adequately be provided with from 1,5 to 6,0 g/m² dry weight of the coating, preferably from 3 to 4 g/m² (corresponding to thicknesses of the base coating layer of 3 to 4 μ)

According to still another preferred feature of the invention the label ideally constitutes a printed transparent or translucent plastic label.

The new label technology according to the invention specifically relates to plastic labels as defined above,
in particular transparent or translucent plastic label, suitable as cut and stack label for application on normal wet glue labelling equipment,

to methods for producing such plastic labels,
in particular, transparent or translucent plastic labels, suitable as cut and stack labels for application on normal wet glue labelling equipment, and

to the use of such plastic labels on containers,
in particular on glass beverage containers.

Further details of the invention will be apparent from the description, here below, of preferred variants for embodying the invention

A. Printing Process: Gravure, Offset Or Flexo Printing.
printing in reels
printing on OPP film
surface or reverse printing on the film.
solvent, UV or waterbased inks
antistatic coating applied on the frontside or reverse,
micro absorbent coating according to the invention. This layer facilitates the absorption of the glue's water during the labelling process. It can be coloured to match the colour of the bottle.

At the end of the printing process, printed reels are obtained.

B. Cutting
the reels are cut into sheets.
during the sheet cutting, embossing can be achieved in-line;
embossing is useful for proper dispersion of the glue and for improved drying of the glue after labelling; embossing can be obtained with iron/cardboard or iron/iron cylinders. the sheets are cut into strips and then into square cut size.
following the customer's request, they can also be cut using a die-cutting tool
It is also possible to achieve the embossing and the converting in-line with a kiss-cutting cylinder.
Cutting can for instance be carried out on standard sheet cutters type Strachan Henschaw or equivalent

C. Embossing/Packaging
Use of specific embossing cylinders; embossing can suitably be carried out at the cutting stage
The labels are assembled into bundles (bundled with an elastic band, PE film or kraft paper).
The bundle contains from 1000 to 1250 labels.
They are put in cardboard boxes.

Merits Of The New Technology:

a) Facility Of Label Production

The process according to the invention can be used on standard printing equipment, as far as it is suitable for plastic printing. This applies to all production process in reels, including rotogravure, rotary offset and flexo printing

b) Facility Of Label Application

The new label according to the invention applied to beverage containers (bottles) in a similar way as a normal paper label on wet-glue labelling equipment. As most beverage producers are already using such equipment, the invention avoids the necessity for the bottler to invest in new labelling machinery, while still maintaining the productivity advantage over pressure-sensitive labelling lines.

c) Cost Advantage

Due to the advantages cited above (a & b) the invention allows a solution equivalent to pressure-sensitive labels at a variable cost more than 30% lower. Furthermore, as it is no longer required to invest in new labelling equipment, fixed cost savings can be obtained.

d) Easy Industrial Application Of The Invention Are Very Low

Only minimal adaptations are required to existing labelling machinery

No investment in new labelling lines is necessary

If all elements of the production process and of the labelling process are respected, operators can be instructed quickly building on their existing knowledge.

Optimal Labelling Conditions:

a) Glue:
1. Specific glue
2. Temperature: 20-35° C.
3. Avoid air bubbles building up during the application
4. Cleaning with water<30° C.
5. Optimal quantity at 12 g/m² for uniform spreading

b) Label:
1. Illoclear preparation (chemical and mechanical)
2. Printing of a frame following the labelling conditions
3. Embossing

c) Bottle:
1. Dry
2. Bottles with straight walls
3. Bottle temperature from 10 to 30° C.
4. Surface tension>38 mN/cm
5. With recess

d) Labelling Machine:
1. Good maintenance of machine
2. Glue roller and blade in good shape
3. Size of the glue pallet<+/−0.5 mm
4. Small grippers (to avoid unglued areas)
5. Medium hard sponge (type Al foil)
6. Brushes (type Al foil)

The preferred features of the label production process

The preferred features of the labels are: a substrate, inks and varnishes.

a. Substrate: Film BOPP (bi oriented polypropylene, co-extruded):
from 50 to 80 microns
clear i.e. transparent.

potential suppliers:
TREOFAN
UCB
EXXON Mobil

b. Inks And Varnishes:

potential suppliers are:
Sun Chemical
Sicpa

c. Essential Properties Of The Coating Elements:

| Elements | Type | Weight |
|---|---|---|
| Nitro-cellulose-acrylic | In 50/50 composition | 87-89% |
| Pigments | Mineral and organic (polyethylene) | 10-12% |
| Antistatic agent | Quaternary ammonium salt | <1% |

The coating is applied to the reverse side (relative to the print side) of the label.

Measuring the micro-absorbtion properties of the labels according to the invention:

the micro-absorption can be measured by either one of the following methods.
a. by placing the label on a damp surface and measuring (by conductivity) the water penetration speed of the glue (backside to frontside).
The specification is from 15 to 30 seconds.
b. by evaluating the setting time on the bottling line.
This evaluation is carried out at the end of the labelling by pressing the finger on the label. The latter must stay in place at the latest 10 seconds after being labelled.

### EXAMPLE

Coating Formulation For Transparent Polypropylene Labels (For gravure Printing Application At 3,9 g/m², 380 m/min)

10,0% standard nitrocellulose base coating (from supplier “Bergerac”)

6,0% standard acrylic base coating (from supplier “Zenica”)

4,0% standard polyurethane base coating (from supplier “Reichold”)

5,0% “polyethylene pigments” from supplier “Clariant”

1,0% standard antistatic agent from supplier “Ceca/Ato”

35,0% solvent grade ethanol from supplier British Petroleum

39,0% solvent grade ethyl acetate from supplier British Petroleum

While specific embodiments and applications of this invention have been shown and described, it should be clear to those skilled in the art that many more modifications and applications are possible without departing from the inventive concepts herein.

The invention is, therefore, not to be restricted in any way, except in the spirit of the appended claims.

1. Transparent or translucent plastic label, suitable as cut and stack label for application on normal wet glue labelling equipment, comprising a label base of plastic sheet material provided with a polymeric base coating, optionally comprising mineral pigments and/or antistatic agent(s), wherein said coating is provided with micro-absorption properties for water.

2. Plastic label according to claim 1, wherein the coating comprises at least 50% of nitro-cellulose, polyurethane, polyamide, acrylate, polyvinyl butyral, polyvinyl and/or cellulose acetate base coating.

3. Plastic label according to claim 2, wherein the coating comprises at least 50% of nitro-cellulose base coating material, acrylate base coating material and/or polyurethane base coating material.

4. Plastic label according to claim 1, wherein the label base comprises a plastic sheet material selected from polyolefin, polyester or cellulose.

5. Plastic label according to claim 4, wherein the label base comprises a plastic sheet material selected from oriented or bis-oriented polypropylene, having a density equal to or above 0,9 g/cc.

6. Transparent or translucent plastic label, suitable as cut and stack label for application on normal wet glue labelling equipment, comprising a label base of plastic sheet material provided with a polymeric base coating, optionally comprising mineral pigments and/or antistatic agent(s), wherein the polymeric base coating comprises a nitro-cellulose base coating material whereas the coating contains a particulate filler material having a particle size ranging from 5 to 50 , and the average thickness of the polymeric coating ranges from 10 to 75% of the average particle size of the particulate filler material.

7. Plastic label according to claim 6, wherein the coating comprises at least 50% of nitro-cellulose, polyurethane, polyamide, acrylate, polyvinyl butyral, polyvinyl and/or cellulose acetate base coating.

8. Plastic label according to claim 7, wherein the coating comprises at least 50% of nitro-cellulose base coating material, acrylate base coating material and/or polyurethane base coating material.

9. Plastic label according to claim 6, wherein the particulate filler material is chosen from mineral filler materials, polymeric filler powders, microsphere glass fillers and microwax dispersions.

10. Plastic label according to claim 6, wherein the label base comprises a plastic sheet material selected from polyolefin, polyester or cellulose.

11. Plastic label according to claim 10, wherein the label base comprises a plastic sheet material selected from oriented or bis-oriented polypropylene, having a density equal to or above 0,9 g/cc.

12. Transparent or translucent plastic label, suitable as cut and stack label for application on normal wet glue labelling equipment, comprising a label base of plastic sheet material provided with a polymeric base coating, optionally comprising mineral pigments and/or antistatic agent(s), wherein the polymeric base coating comprises a nitro-cellulose base coating material whereas the coating contains a particulate filler material having a particle size ranging from 5 to 50, and the average thickness of the polymeric coating ranges from 10 to 75% of the average particle size of the particulate filler material, so that the coating shows micro-absorption properties for water.

13. Plastic label according to claim 12, wherein the coating comprises at least 50% of nitro-cellulose, polyurethane, polyamide, acrylate, polyvinyl butyral, polyvinyl and/or cellulose acetate base coating.

14. Plastic label according to claim 13, wherein the coating comprises at least 50% of nitro-cellulose base coating material, acrylate base coating material and/or polyurethane base coating material.

15. Plastic label according to claim 12, wherein the particulate filler material is chosen from mineral filler materials, polymeric filler powders, microsphere glass fillers and microwax dispersions.

16. Plastic label according to claim 12, wherein the label base comprises a plastic sheet material selected from polyolefin, polyester or cellulose.

17. Plastic label according to claim 16, wherein the label base comprises a plastic sheet material selected from oriented or bis-oriented polypropylene, having a density equal to or above 0,9 g/cc.

18. Method for producing transparent or translucent plastic labels, suitable as cut and stack labels for application on normal wet glue labelling equipment, comprising providing a transparent or translucent plastic sheet material with a polymeric base coating, optionally comprising mineral pigments and/or antistatic agent(s), wherein a polymeric base coating comprising a nitro-cellulose base coating material and containing a particulate filler material having a particle size ranging from 5 to 50 is applied to a plastic sheet material, as a dispersion of the particulate filler in a solution of the base coating material in a volatile solvent, so that the average thickness of the polymeric coating, after evaporation of the solvent, ranges from 10 to 75% of the average particle size of the particulate filler material.

19. Method according to claim 18, wherein the base coating material comprises at least 50% of nitro-cellulose, polyurethane, polyamide, acrylate, polyvinyl butyral, polyvinyl and/or cellulose acetate base coating.

20. Method according to claim 18, wherein the base coating material comprises at least 50% of nitro-cellulose base coating material, acrylate base coating material and/or polyurethane base coating material.

21. Method according to claim 18, wherein the particulate filler material is chosen from mineral filler materials, polymeric filler powders, microsphere glass fillers and microwax dispersions.

22. Method according to claims 18, wherein the label base comprises a plastic sheet material selected from polyolefin, polyester or cellulose.

23. Method according to claim 18, wherein the label base comprises a plastic sheet material selected from oriented or bis-oriented polypropylene, having a density equal to or above 0,9 g/cc.

24. Method for producing printed transparent or translucent plastic labels, suitable as cut and stack labels for application on normal wet glue labelling equipment, comprising providing a transparent or translucent plastic sheet material with a polymeric base coating, optionally comprising mineral pigments and/or antistatic agent(s), wherein a polymeric base coating comprising a nitro-cellulose base coating material and containing a particulate filler material having a particle size ranging from 5 to 50 is applied to a plastic sheet material, before, during, or after the printing stage, as a dispersion of the particulate filler in a solution of the base coating material in a volatile solvent, so that the average thickness of the polymeric coating, after evaporation of the solvent, ranges from 10 to 75% of the average particle size of the particulate filler material.

25. Method according to claims 24, wherein the base coating material comprises at least 50% of nitro-cellulose, polyurethane, polyamide, acrylate, polyvinyl butyral, polyvinyl and/or cellulose acetate base coating.

26. Method according to claims 24, wherein the base coating material comprises at least 50% of nitro-cellulose base coating material, acrylate base coating material and/or polyurethane base coating material.

27. Method according to claim 24, wherein the particulate filler material is chosen from mineral filler materials, polymeric filler powders, microsphere glass fillers and microwax dispersions.

28. Method according to claim 24, wherein the label base comprises a plastic sheet material selected from polyolefin, polyester or cellulose.

29. Method according to claim 24, wherein the label base comprises a plastic sheet material selected from oriented or bis-oriented polypropylene, having a density equal to or above 0,9 g/cc.

30. Use of a label according to claim 1, on a glass beverage container, applying normal wet glue labelling technology.
